(19) United States
(12) Patent Application Publication
(10) Pub. No.: US 2007/0104084 A1
(43) Pub. Date: May 10, 2007

(54) External optical disk stabilizer and method of use

(76) Inventor: Kuo Ching Chen, Newark, CA (US)

Correspondence Address: FORTUNE LAW GROUP LLP, 100 CENTURY CENTER COURT, SUITE 315, SAN JOSE, CA, 95112, US

(21) Appl. No.: 11/267,881

(22) Filed: Nov. 7, 2005

(51) Int. Cl. G11B 3/70

(52) U.S. Cl. 369/290.1

(57) ABSTRACT

An external optical disk stabilizer, for use in stabilizing an optical disk comprising a coating of self-adhesive material set to a non-recording side of an optical disk substrate. The self-adhesive viscous material includes silicon gel, epoxy or other like material. The stabilizer may include a thin sheet of dampening material permanently or non-permanently applied over the non-recording side. The stabilizer may also sandwich the optical disk therebetween.

### BACKGROUND OF THE INVENTION

1. Field of the Invention

The present invention relates to external optical disk stabilizers, and in particular, an external optical disk stabilizer adapted to be applied over the non-recording side and/or recording side of a single-sided optical disk to stabilize the optical disk for improved performance when rotated at high speeds.

2. General Background

Optical data storage media with higher densities are highly desirable. Accordingly, to access the data, the speed of disk drivers are increasing thus increasing the rotational speed of single-sided or double-sided optical disks. For example, rotational speeds may increase to or above 3000 rpms with a trend to increase to much higher speeds.

Improved optical data storage media include read only disks, write once disks, magneto-optical disks, rewritable disks, double-sided recording disks, etc. The operation of the drivers for each optical data storage media differs based on the type of disk and all have been well established in the industry. For the sake of illustration, one driver will be described briefly below.

A write once/read many driver uses a laser beam to make a permanent mark on a thin film of the recording side on the disk to write and store data. The stored data is then read out as a change in the optical properties of the disk, such as reflectivity or absorbance. When optical disks are rotated at high rotational speeds, the drivers have problems reading from and recording (writing) to such optical disks as the result of vibrational forces. Vibrational forces cause the optical disks to vibrate or wobble resulting in tracking problems for the laser device of the driver to direct the laser beam to make the mark or read the mark.

### SUMMARY OF THE INVENTION

The present invention contemplates an external optical disk stabilizer, for use in stabilizing an optical disk when the optical disk is rotated, comprising: a self-adhesive viscous material coated on and set to a non-recording or recording side of an optical disk substrate forming one or more layers of dampening material.

The present invention contemplates an external optical disk stabilizer that can sandwich the optical disk therebetween.

The present invention also contemplates a method of stabilizing an optical disk for high speed rotation comprising the steps of:

coating a self-adhering material to a non-recording or recording side of an optical disk substrate;

setting the self-adhering material to form one or more external layers of dampening material on the optical disk substrate; and,

stabilizing said optical disk during high speed rotation via the external layer(s) of the dampening material.

The self-adhering material includes silicon gel, epoxy, Teflon or the like.

Furthermore, the present invention contemplates an external stabilizing device that includes at least one layer of dampening material that can be used with either single-sided or double-sided recording optical disks.

The at least one layer of dampening material comprises dried self-adhering material coating a thin sheet of dampening material.

The above and other objects and features of the present invention will become apparent from the drawings, the description given herein, and the appended claims.

### BRIEF DESCRIPTION OF THE DRAWINGS

For a further understanding of the nature, objects, and advantages of the present invention, reference should be had to the following detailed description, taken in conjunction with the accompanying drawings, in which like reference numerals denote like elements.

FIG. 1A illustrates an exploded perspective view of the external optical disk stabilizer over a non-recording side of an optical disk in accordance with the present invention.

FIG. 1B illustrates an exploded perspective view of the external optical disk stabilizer over a recording side of an optical disk in accordance with the present invention.

FIG. 1C illustrates an exploded perspective view of an external optical disk stabilizer sandwiching an optical disk therebetween in accordance with the present invention.

FIG. 2 illustrates the external optical disk stabilizer applied to an optical disk with a portion of the stabilizer removed (shown hatched) in accordance with the embodiment of FIG. 1A.

FIG. 3 illustrates an exploded perspective view of an alternate embodiment of the external optical disk stabilizer over an optical disk in accordance with the present invention.

FIG. 4 illustrates an exploded perspective view of another alternate embodiment of the external optical disk stabilizer over an optical disk in accordance with the present invention with a portion of the first layer removed (shown hatched).

FIG. 5 illustrates an exploded perspective view of a still further alternate embodiment of the external optical disk stabilizer over an optical disk in accordance with the present invention with a portion of the first layer removed.

FIG. 6 illustrates an exploded perspective view of a still further alternate embodiment of the external optical disk stabilizer over the recording and non-recording sides of an optical disk in accordance with the present invention.

### DETAILED DESCRIPTION OF THE PREFERRED EMBODIMENTS

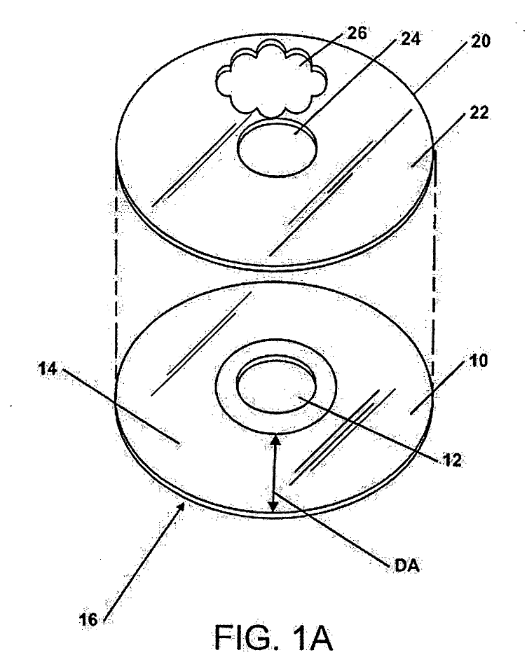

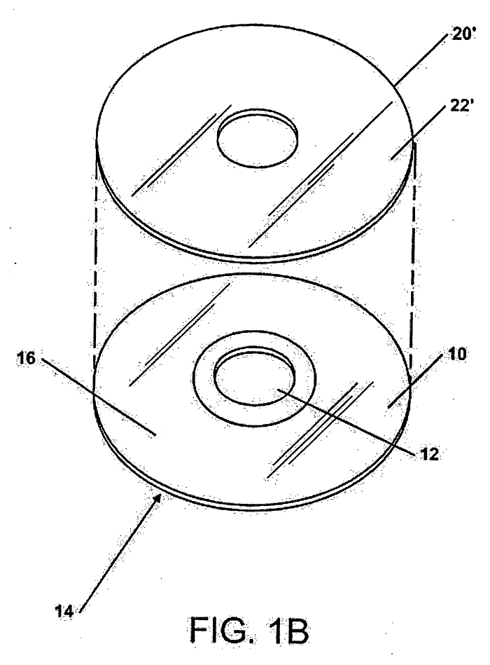

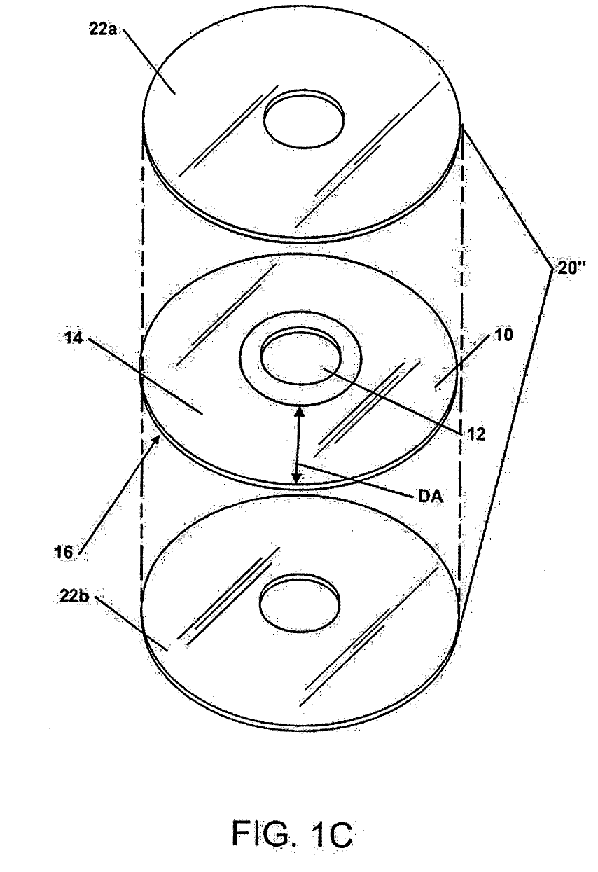

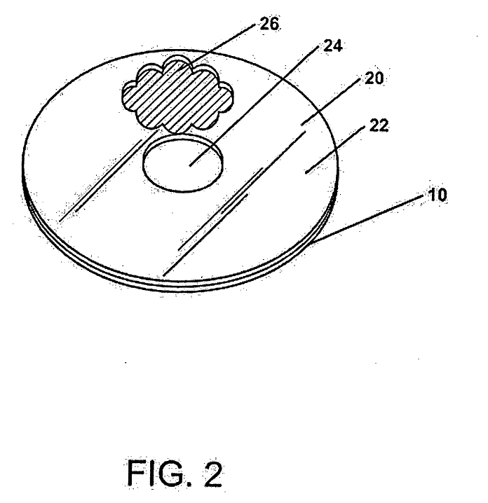

Referring now to FIGS. 1A and 2, the external optical disk stabilizer of the present invention is referenced by the numeral 20 with the optical disk reference by the numeral 10. The optical disk 10 is defined by a substrate having a center aperture 12. The optical disk 10 includes a non-recording side 14 and a recording side 16 with a data storage area confined within the area designated by DA. The industry specifications on optical disks 10 are generally detailed in ANSI specifications and are well established. Thus, no further description related to optical disks is necessary. Although, the embodiments illustrated herein show an optical disk with a circular substrate, other substrate shapes may be used.

The external optical disk stabilizer 20 is an even layer 22 of dampening material dimensioned to cover the substrate area of the non-recording side 14. For illustrative purposes, a portion of the layer 22 of dampening material has been removed forming hole 26 to expose the surface of the non-recording side 14 (shown hatched in FIG. 2).

With reference to FIG. 1B, the external optical disk stabilizer 20′ is an even layer 22′ applied to cover the substrate area of the recording side 16. Nevertheless, external optical disk stabilizer 20″ (as best seen in FIG. 1C) may be employed wherein an even layer 22a is applied to the non-recording side and even layer 22b is applied to the recording side so that the optical disk 10 is sandwiched therebetween.

In the exemplary embodiment, the stabilizer 20 extends from the outer perimeter edge of the optical disk 10 to or just before the interior edge of the center aperture 12. Accordingly, when the layer 22 of dampening material is applied a center aperture 24 is formed.

In the embodiment of FIGS. 1A and 2, the layer 22 of dampening material is formed by the application or coating of a self-adhering viscous material or gel onto the non-recording side 14. Silicon gel is but one example of a self-adhering viscous material. The silicon gel can be spread, applied or coated on the non-recording side 14 of optical disk 10 to form an even layer. Thereafter, the silicon gel is left to set or, otherwise, dry for a predetermined time until the self-adhering viscous material can no longer be spread or applied. After the silicon gel is set, the layer 22 of dampening material is formed over the non-recording side 14. Thus, the optical disk 10 can then be place in the optical disk driver (NOT SHOWN).

The self-adhering viscous material is set when touching the material does not subsequently self-adhere to another contacting surface, item, finger, etc.

Another example of a self-adhering viscous material or rapidly drying self-adhering material is epoxy and Teflon. The epoxy is applied, spread or coated and then left to set. Furthermore, when applying the self-adhering material care should be taken to prevent application thereof to the recording side 16 of the optical disk 10. The thickness of the layer 22 of dampening material should not exceed the maximum allowable optical disk thickness of the ANSI specifications or other specifications for use in optical disk drivers.

The method of stabilizing an optical disk 10 for high speed rotation includes: 1) applying, spreading or coating a self-adhering viscous material to the non-recording side of the optical disk 10; 2) setting or drying the viscous material to form an external layer 22 of dampening material; and 3) stabilizing said optical disk 10 during high speed rotation via the layer 22 of dampening material.

I have determined that the use of a self-adhering viscous material, such as silicon gel, enhances the recording and reading capability of the driver as it stabilizes the optical disk 10, especially for high fidelity recordings. While not wishing to be bound by theory, other self-adhering viscous materials or rapidly drying self-adhering material may be substituted.

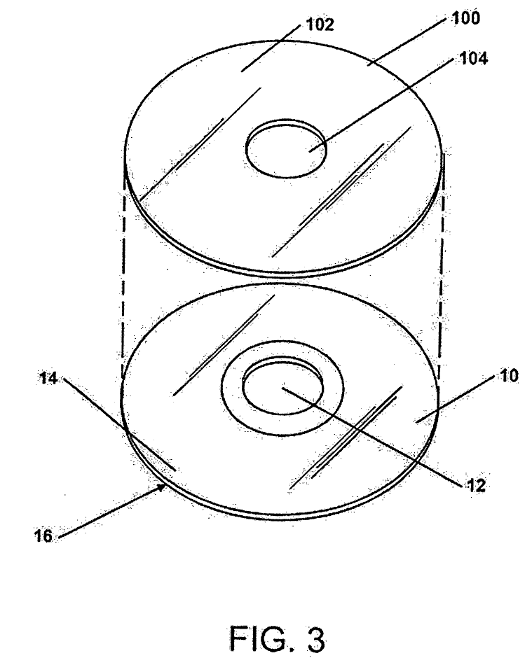

Referring now to FIG. 3, in an alternate embodiment, the external optical disk stabilizer 100 is a thin membrane, film or sheet 102 of dampening material adapted to be place non-permanently over the non-recording side 14 of the optical disk 10. In this embodiment, the external optical disk stabilizer 100 is adapted to be removed. Therefore, the thin membrane, film or sheet 102 of dampening material can be used with single-sided recording or double-sided recording optical disks. When recording using a double-sided recording optical disk, the optical disk stabilizer 100 is simply placed over that side deemed the non-recording side 14 in the driver.

The external optical disk stabilizer 100 extends from the outer perimeter edge of the optical disk 10 to or just before the interior edge of the center aperture 12. Accordingly, the thin membrane, film or sheet 102 of dampening material has a center aperture 124 formed therein.

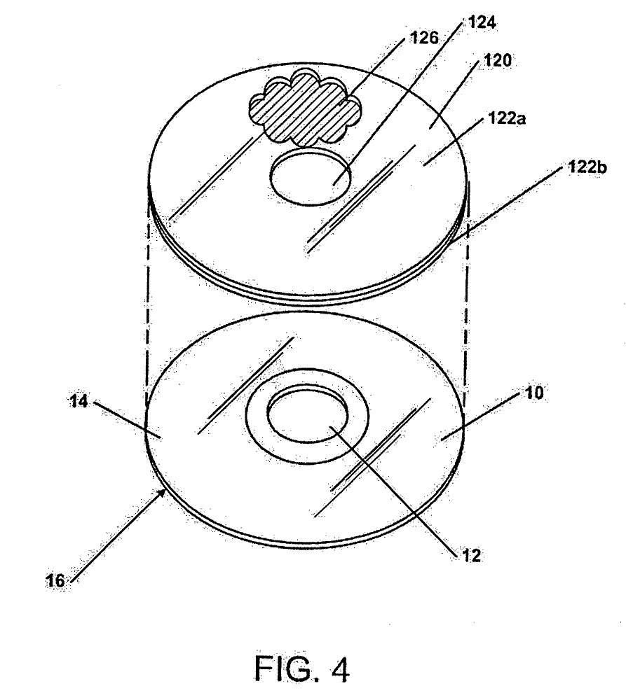

Referring now to FIG. 4, the external optical disk stabilizer 120 includes two layers 122a and 122b of dampening material, each with center aperture 124. In this embodiment, the two layers 122a and 122b may be separate or non-attached to the other. In this case, the two layers 122a and 122b each would comprise the thin membrane, film or sheet 102 of dampening material, as set forth in FIG. 3. The bottom layer 122b is adapted to be non-permanently place over the non-recording side 14 of the optical disk 10.

Alternately, one layer (bottom layer 122b) would comprise the thin membrane, film or sheet of dampening material, as set forth in FIG. 3. The second layer (top layer 122a) is a layer of dampening material formed by the application of a self-adhering viscous material directly to the top of the bottom layer 122b.

In these two embodiments related to FIG. 4, the external optical disk stabilizer 120 is adapted to be removed. Therefore, the external optical disk stabilizer 120 can be used with single-sided recording or double-sided recording optical disks. When recording using a double-sided recording optical disk, the optical disk stabilizer 120 is simply placed over the non-recording side 14.

In the embodiment of FIG. 4, the layer of dampening material formed by the application of a self-adhering viscous material is applied to the second layer 120 in the manner as described above in relation to FIGS. 1A and 2. For illustrative purposes only, the hole 126 formed in the top layer 122a exposes the second layer 122b (shown hatched).

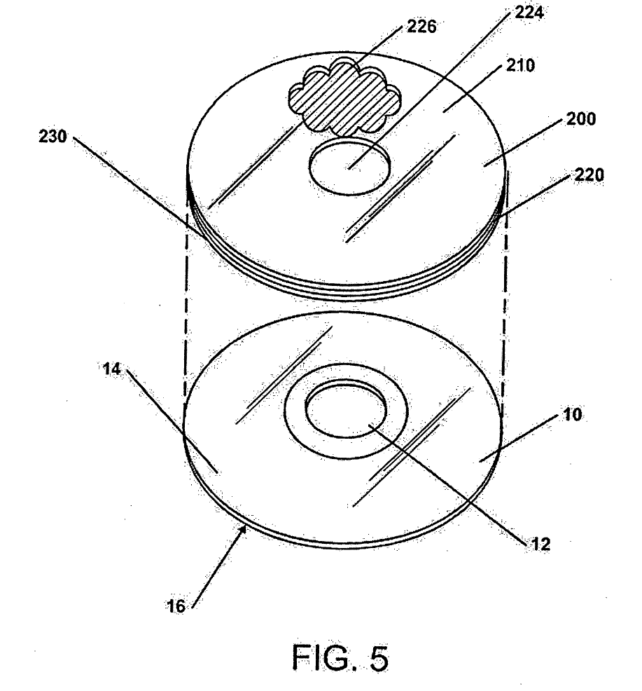

Referring now to FIG. 5, the external optical disk stabilizer 200 includes two layers 210, 230 of dampening material and an adhesive layer 220 for attachment of the second bottom layer 230 (a thin membrane, film or sheet of dampening material) permanently over the non-recording side 14 of the optical disk 10.

The thickness of the thin membrane, film or sheet 102 of dampening material may be the thickness of one sheet of paper, two sheets of paper or less than the thickness of a sheet of paper.

The thin membrane, film or sheet 102 of dampening material may include Teflon, vinyl, PVC, epoxy or silicon.

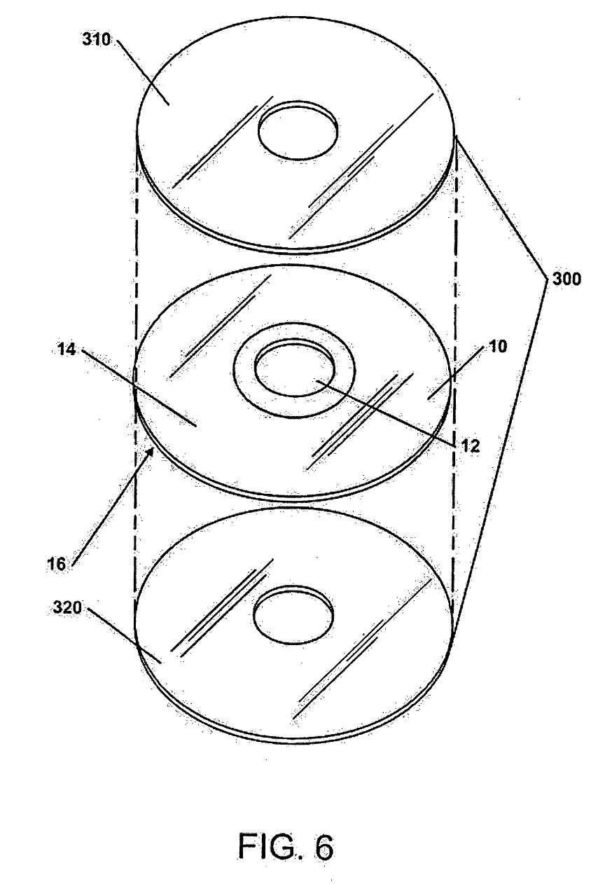

Referring now two FIG. 6, the external optical disk stabilizer 300 includes two layers 310, 320 of dampening material arranged such that the optical disk 10 is sandwiched therebetween. As can be appreciated, layer 310 can be permanently or non-permanently affixed to the non-recording side 14.

Because many varying and differing embodiments may be made within the scope of the inventive concept herein taught and because many modifications may be made in the embodiments herein detailed in accordance with the descriptive requirement of the law, it is to be understood that the details herein are to be interpreted as illustrative and not in a limiting sense.

I claim:

1. An external optical disk stabilizer, for use in stabilizing an optical disk when the optical disk is rotated, comprising:
self-adhesive material coated on and set to a side of an optical disk substrate forming at least one layer of dampening material.

2. The stabilizer according to claim 1, wherein said self-adhesive material is a self-adhesive viscous material comprising silicon gel.

3. The stabilizer according to claim 1, wherein the self-adhesive material comprises at least one of an epoxy and Teflon.

4. The stabilizer according to claim 1, wherein said layer of dampening material is an even layer.

5. The stabilizer according to claim 1, wherein the side is a recording side.

6. The stabilizer according to claim 1, wherein the side is a non-recording side.

7. The stabilizer according to claim 6, further comprising:
self-adhesive material coated on and set to a recording side of the optical disk substrate forming a second layer of dampening material.

8. An external optical disk stabilizer, for use in stabilizing an optical disk when the optical disk is rotated, comprising:
at lease one thin sheet of dampening material adapted to be placed over a side of an optical disk substrate.

9. The stabilizer according to claim 8, further comprising:
an adhesive layer coupled to an underside of said thin sheet of the dampening material wherein said adhesive layer is adapted to be permanently affixed to said side.

10. The stabilizer according to claim 8 wherein:
said thin sheet of the dampening material is removably placed over said side; and
said side being one of a recording side and a non-recording side.

11. The stabilizer according to claim 8, further comprising:
a self-adhesive material coated on and set to said thin sheet of the dampening material forming a second layer of the dampening material.

12. The stabilizer according to claim 11, wherein said self-adhesive material comprises at least one of epoxy material and Teflon.

13. The stabilizer according to claim 11, wherein said self-adhesive material is a viscous material comprising a silicon gel.

14. The stabilizer according to claim 8, further comprising:
a second thin sheet of the dampening material forming a second layer of the dampening material.

15. The stabilizer according to claim 14, wherein:
said second thin sheet of the dampening material is positioned over a second side of said optical disk substrate;
said side being a non-recording side; and,
said second side being a recording side.

16. The stabilizer according to claim 14, wherein said second thin sheet of the dampening material is non-permanently affixed over said thin sheet.

17. A method of stabilizing an optical disk for high speed rotation comprising the steps of:
coating a self-adhering material to a side of an optical disk substrate;
setting the self-adhering material to form at least one external layer of dampening material on the optical disk substrate; and,
stabilizing said optical disk during high speed rotation via the external layer of the dampening material.

18. The method according to claim 17, wherein said self-adhering material comprises at least one of epoxy material and Teflon.

19. The method according to claim 17, wherein said self-adhesive material is a viscous material comprising silicon gel.

20. The method according to claim 17, wherein:
said side is a non-recording side; and,
the coating step comprises:
evenly coating the self-adhering material without application of the self-adhering material to a recording side of the optical disk substrate.
